(19) United States
(12) Patent Application Publication
(10) Pub. No.: US 2026/0336386 A1
(43) Pub. Date: Oct. 29, 2026

(54) Motor Vehicle

(71) Applicant: Bayerische Motoren Werke Aktiengesellschaft, Muenchen (DE)

(72) Inventors: Oeztzan AKIF, Muenchen (DE); Christian BOEHM, Muenchen (DE); Thomas FIALA, Muenchen (DE); Jan WILSMANN, Fuerstenfeldbruck (DE)

(21) Appl. No.: 19/113,591

(22) PCT Filed: Sep. 29, 2023
(86) PCT No.: PCT/EP2023/077029

§ 371 Date: Mar. 20, 2025

(30) Foreign Application Priority Data
Oct. 7, 2022 (DE) 10 2022 125 893.9

(51) Int. Cl. B60K 11/08; B60K 11/04

(52) U.S. Cl. CPC B60K 11/085; B60K 11/04

(57) ABSTRACT

A motor vehicle has at least one heat exchanger through which a fluid can flow and around which air can flow, via which heat exchanger the temperature of the fluid can be controlled by the air, and an air path through which the air can flow and via which the air is to be fed to the heat exchanger in order to supply the heat exchanger with the air. A bumper cover is arranged on the front of the motor vehicle, wherein the bumper cover has a first cover part forming a first part of an external skin of the motor vehicle and a second cover part forming a second part of the external skin, which second cover part can be pivoted between at least two positions relative to the first cover part.

### BACKGROUND AND SUMMARY

The invention relates to a motor vehicle and, in particular, a motor vehicle having at least one heat exchanger through which a fluid can flow and around which air can flow and by which the fluid is to be temperature-controlled via the air. A bumper cover is arranged on a front of the motor vehicle,

DE 10 2014 001 927 B4 discloses a vehicle with a radiator grille shutter structure. In addition, DE 10 2014 219 747 A1 describes a motor vehicle with an engine or genset compartment through which cooling air can flow and with an underbody cladding mounted under the engine or genset compartment facing the road.

The problem addressed by the present invention is to create a motor vehicle so that particularly advantageous aerodynamics of the motor vehicle can be realized.

According to the invention, this problem is solved by a motor vehicle with the features of the independent claim(s). Advantageous embodiments of the invention are the subject of the dependent claims.

The invention relates to a motor vehicle, also simply referred to as a vehicle and preferably designed as a motor car, most preferably a passenger car, the interior of which, also referred to as the passenger compartment or passenger cell, is formed, for example, by a body designed in particular as a self-supporting body. The motor vehicle has at least one heat exchanger through which a fluid, in particular in the form of a liquid, can flow and around which air can flow, which is also referred to as an ambient air heat exchanger or is designed as an ambient air heat exchanger. In particular this means that the air is preferably ambient air, which flows onto and around the heat exchanger, for example as a result of the vehicle being driven forward. In particular, the air, which is also referred to as temperature control air, is or results from an airstream or the air (temperature control air) is formed by the airstream, which flows onto and around the heat exchanger when the vehicle is driven forward. In particular, in the vehicle state an airflow of the air through a fan attached for example to the heat exchanger is generated. The fluid can be temperature-controlled, i.e. cooled and/or heated, by means of the air via the heat exchanger, in particular by exchanging heat via the heat exchanger between the fluid flowing through the heat exchanger and the air flowing around the heat exchanger.

If, for example, the air has a lower temperature than the fluid, the air is or functions as cooling air, and the heat exchanger is or functions as a radiator, in particular as an ambient air radiator, via which the fluid is to be cooled by means of the air. If, for example, the air has a higher temperature than the fluid, the air is or acts as a heating medium, wherein the fluid is heated or is to be heated by means of the air via the heat exchanger. This can be provided in a heat pump drive.

The motor vehicle also has an air path through which the air can flow, via which the air can be supplied to the heat exchanger in order to supply the heat exchanger with air. In other words, the air flowing through the air path can be directed to the heat exchanger by means of the air path, whereby the heat exchanger can be supplied or is supplied with air. For example, the air path ends at the heat exchanger, so that the heat exchanger is arranged downstream of the air path, particularly in the direction of flow of the air flowing through the air path. It is preferable for the air path to be arranged at least partially, in particular at least predominantly and thus at least more than half or completely, upstream of the heat exchanger in the vehicle longitudinal direction. Very preferably, the heat exchanger is arranged at the front of the motor vehicle.

The motor vehicle also has a bumper cover arranged at the front of the motor vehicle, by means of which, for example, a bumper of the motor vehicle is covered on both sides in the vehicle longitudinal direction towards the front and, for example, in the vehicle transverse direction towards the outside and is thus covered. The bumper is or comprises, for example, a bending crossmember extending at least in the vehicle transverse direction, which is also referred to as the first crossmember or is a first crossmember of the vehicle. In particular the bending crossmember is part of the body.

The fluid can be used, for example, to cool at least one component of the vehicle, which is provided in particular in addition to the heat exchanger. The component is or comprises, for example, an electric machine by means of which the motor vehicle can be driven, in particular purely electrically. Alternatively or additionally, the component is or comprises, for example, an electrical energy storage device, also known as a battery, by means of which electrical energy, in particular electrochemical energy, is stored or can be stored. Preferably, the electric machine and/or the energy storage device are a high-voltage component of which the electrical voltage, in particular electrical operating or rated voltage, is preferably greater than 50 volts, in particular greater than 60 volts, and very preferably amounts to several hundred volts. For example, in order to drive the motor vehicle by means of the electric machine, the electric machine is supplied with the electrical energy stored in the energy store. The motor vehicle is designed, for example, as a hybrid vehicle or as an electric vehicle, in particular as a battery electric vehicle (BEV). In particular, the component can be cooled by transferring heat from the component to the fluid flowing through the component. This heats the fluid acting or designed as a cooling medium, wherein the fluid can be cooled by means of the heat exchanger.

In order to realize a particularly advantageous aerodynamics of the motor vehicle as well as a particularly demand-oriented temperature control, i.e., cooling and/or heating of the fluid, it is provided according to the invention that the bumper cover has a first cover part forming a first part of an external skin of the motor vehicle and a second cover part forming a second part of the external skin. The external skin is a surface which can be visually and haptically perceived by persons outside the motor vehicle and thus in a surrounding environment of the motor vehicle, the external skin of which can thus be visually observed and touched by the persons, in particular in the fully manufactured state of the motor vehicle. The second cover part is actively pivotable relative to the first cover part and in particular, while the first cover part remains stationary, between at least two positions, in particular about a pivot axis. In at least one of the positions, an inflow opening of the air path, also known as the flow path, into the air from the surrounding environment of the motor vehicle can be introduced via the inflow opening, is directly delimited upwards in the vehicle's vertical direction through a partial area of the first cover part and downwards in the vehicle's vertical direction through an end edge of the second cover part arranged below the partial area in the at least one position in the vehicle's vertical direction. The second cover part ends at the aforementioned end edge, which is also referred to as the first end edge. When the end edge is referred to in the following, this is understood to mean the first end edge of the second cover part, unless otherwise specified. For example, the partial area of the first cover part may be a second end edge of the first cover part, which ends at the second end edge.

In the at least one position, the inflow opening has a flow cross-section through which the air can flow and which is larger than zero, which in the at least one position is the smallest flow cross-section of the air path (flow path) through which the air can flow. Since the flow cross-section is greater than zero in the at least one position, the inflow opening is open in the at least one position, so that the at least one position is an open position of the second cover part. In the at least one position, in particular when the motor vehicle is moving forward, the air, in particular from the surrounding environment of the motor vehicle, can flow through the inflow opening, which is open or open in the at least one position, and thus flow into the air path via the inflow opening and subsequently flow through the air path, wherein the air is guided towards the heat exchanger by means of the air path. In this way, the air is supplied to the heat exchanger. The air can then flow to and around the heat exchanger. In the direction of flow of the air flowing through the air path and thus flowing towards the heat exchanger, the inlet opening, also known as the inflow opening, is arranged upstream of the heat exchanger. In particular, the inflow opening is arranged upstream of the heat exchanger in the vehicle longitudinal direction, i.e., further forward than the heat exchanger, wherein it is quite preferably provided that the entire air path is arranged ahead of the heat exchanger in the vehicle longitudinal direction of the motor vehicle. In particular, it is provided that the air path begins at the inlet opening and thus ends above the inlet opening to the surrounding environment or into the surrounding environment, wherein the air path preferably ends at the heat exchanger.

For example, the air path is an air duct, also known simply as a duct, which, for example, extends from the inlet opening to the heat exchanger, in particular continuously and thus without interruption. In particular, it is intended that the air duct, in particular along its entire extension from the inflow opening to the heat exchanger, is completely circumscribed and thus formed in the circumferential direction of the air duct by a duct element, in particular in the form of a solid body, so that the air can be guided to the heat exchanger in a precise and defined manner. The duct element comprises, for example, the cover parts and, for example, a duct element that is separate from the cover parts and connected to the cover parts, which can be designed in one piece or in one or more parts. For example, the line element extends from the cover parts, in particular in a continuous or uninterrupted manner, to the heat exchanger.

The end edge of the second cover part is also referred to as a lip or edge or forms a lip, which is also referred to as a bottom lip or lower lip, since the end edge is arranged below the partial area of the first cover part in the at least one position in the vehicle vertical direction of the motor vehicle. Quite preferably, it is provided that in the at least one position the inflow opening is arranged in a lower quarter, in particular lower third, of a height of the motor vehicle extending in the vehicle vertical direction, as viewed in the vehicle vertical direction, so that on the one hand particularly advantageous aerodynamics and on the other hand a particularly advantageous supply of air to the heat exchanger can be realized. As a result of the invention, an excessive air resistance of the motor vehicle resulting from the supply of air to the heat exchanger can be kept particularly low, especially when the motor vehicle is moving forwards, so that the motor vehicle can be driven in a particularly energy-efficient manner.

The second cover part can be pivoted between the positions as required in order supply the heat exchanger with air as required in a particularly aerodynamically favorable manner.

In order to achieve particularly advantageous aerodynamics, it has been shown to be particularly advantageous if the pivot axis, about which the second cover part can be pivoted relative to the first cover part between the positions, runs in the vehicle transverse direction.

In order realize particularly advantageous aerodynamics of the motor vehicle and a particularly demand-oriented supply of air to the heat exchanger, it is provided in a further embodiment of the invention that in the other position the inflow opening is closed, i.e., reduced to zero, whereby the air path is fluidically blocked. In other words, in the other position, the flow cross-section and thus the inflow opening is reduced to zero, so that no ambient air and thus no air can flow through the inflow opening and enter the air path via the inflow opening even when the vehicle is moving forward.

A further, alternative embodiment provides that, in the other position, the inflow opening of the air path is delimited upwards in the vehicle vertical direction by the partial area of the first cover part and downwards in the vehicle vertical direction by the end edge of the second cover part arranged below the partial area in the other position and in the vehicle vertical direction, in each case directly, wherein the flow cross-section of the inflow opening is larger in the other position than in the at least one position. The flow cross-section in the other position is greater than zero, so that in this embodiment the flow cross-section of the inflow opening and thus the inflow opening are released, i.e. open. This means that even in the other position, the air formed by the airstream, for example, can flow through the inflow opening and thus through the flow cross-section, in particular as a result of the vehicle moving forwards, and thus can flow into the air path via the inflow opening and to the heat exchanger via the air path. A particularly aerodynamically favorable supply to the heat exchanger can thus be realized in a particularly advantageous manner. In this embodiment, the aforementioned open position, i.e., at least one position, is a first open position, with the other position being a second open position.

In order to be able to realize particularly advantageous aerodynamics and thus particularly energy-efficient operation of the motor vehicle, it is provided in a further embodiment of the invention that in the other position the flow cross-section of the inlet opening is the smallest flow cross-section of the air path through which the air can flow.

A further embodiment is distinguished in that the second cover part can be pivoted relative to the first cover part into a third position in which the inflow opening, i.e. the flow cross-section, is closed and the air path is thus fluidically blocked. The third position is therefore a closed position in which the inflow opening and the flow cross-section are reduced to zero. This enables a particularly demand-oriented supply of air to the heat exchanger, so that particularly advantageous aerodynamics of the vehicle can be achieved.

In order to be able to realize particularly advantageous aerodynamics and thus particularly energy-efficient operation of the motor vehicle, it is provided in a further embodiment of the invention that, in the other position, the end edge of the second cover part, with the exception of ground contact elements which are designed, for example, as vehicle wheels and by means of which the motor vehicle can be supported downwards in the vehicle vertical direction of the motor vehicle on a ground along the motor vehicle is to be driven, is the lowest point of the motor vehicle when viewed downwards in the vehicle vertical direction. If the motor vehicle is driven along the ground, for example, while the motor vehicle is supported on the ground above the ground contact elements in the vertical direction of the motor vehicle, the ground contact elements roll, in particular directly, on the ground.

In a further, particularly advantageous embodiment of the invention, the second cover part is held on a crossmember of the motor vehicle so as to be pivotable relative to the first cover part and relative to the crossmember. In particular, the crossmember is provided in addition to the aforementioned bending crossmember and is thus a second crossmember. Quite preferably, the crossmember on which the second cover part is pivotably held is a lower crossmember, thus arranged below the bending crossmember in the vehicle vertical direction, and quite preferably, the crossmember on which the second cover part is pivotably held is the lowest crossmember of the motor vehicle in the vertical direction of motor vehicle.

In a further, particularly advantageous embodiment of the invention, an actuator is provided which can be operated electrically and/or hydraulically and/or pneumatically, for example, and is designed as an electromechanical actuator, by means of which the second cover part can be pivoted relative to the first cover part from the at least one position into the other position and/or from the other position into the at least one position. As a result, the second cover part can be pivoted as required and thus the heat exchanger can be supplied with air as required, so that particularly good aerodynamics of the motor vehicle can be achieved.

For example, a transmission and/or linkage is provided by which the cover part can be moved by means of the actuator.

Preferably, the transmission and/or linkage is self-locking, so that aerodynamic loads acting on the cover part do not have to be supported by the actuator, or only to a small extent.

It has been shown to be particularly advantageous if at least one sealing element is provided, for example formed from an elastically deformable material, in particular rubber, by means of which the cover parts are sealed against each other in at least one position and/or in the other position. This allows a defined air guidance to be realized, so that particularly advantageous aerodynamics of the vehicle can be achieved.

In particular, the invention is based on the following findings and considerations. Usually, motor vehicles emit their waste heat to the surrounding environment with the aid of a cooling module. The cooling module comprises at least or exactly one radiator, which is also referred to as an ambient air radiator or is designed as an ambient air radiator. The cooling module is typically arranged at or near the respective front of the respective motor vehicle. Usually, the air, also referred to as supply air, reaches the cooling module or radiator via at least one or more air inlets at the respective front, also referred to as the vehicle front. An obvious arrangement of the respective air inlet or at least part of it is between the lowest two crossmembers of an accident management system of the respective motor vehicle. The air is collected here from the front through an edge of a front apron, for example in the form of a lip or formed by a lip, and is directed to or at the cooling module via an air guidance system. If necessary, an air flap control is provided, in particular integrated, for example to keep the air resistance low and/or to adjust the amount of air with which the cooling module is supplied. If the air resulting solely from the forward motion and thus from the airstream is not sufficient, a blower can be provided and, in particular, switched on in order to convey the air or a sufficient amount of air to the cooling module.

It is therefore contemplated in the motor vehicle according to the invention that the heat exchanger is assigned the aforementioned fan, also known as a blower, by means of which the air can be forced through the air path and thus the heat exchanger. In the direction of flow of the air flowing through the air path, the blower is preferably arranged downstream of the heat exchanger, wherein it is contemplated in particular that the blower is arranged after the heat exchanger in the vehicle longitudinal direction of the motor vehicle.

In battery electric vehicles (BEV) in particular, the air intake area at the front of the vehicle is minimized due to the requirements for low air resistance. This is possible due to the lower requirements regarding the maximum amount of heat to be dissipated compared to vehicles powered by an internal combustion engine. While in conventional vehicles powered by an internal combustion engine, the temperature control, in particular cooling, at high speeds and with a high load, for example on a hill and in particular when the vehicle is part of a combination, is dimensioned to the air mass flow, in electric vehicles such as battery electric vehicles, at least the temperature control, in particular cooling, is decisive when the vehicle is stationary or close to stationary. The opening cross-section of the air inlets at the front of the vehicle can be a limiting factor here. The main air inlet at the front of the vehicle in electric vehicles is usually located in the center at the lowest possible position, especially when viewed in the vehicle's vertical direction. A downward enlargement of this cross-section is limited by the requirement for as large a ramp angle as possible so that the front end does not touch down during a ride. The lower limit of the air inlet should also meet high requirements in respect of pedestrian protection. In the event of a collision with a pedestrian, this component has a major influence on accident behavior. This should be taken into account when positioning and designing the compliance.

The idea of the invention is now, in particular, in the at least one position, to directly limit the inflow opening, which in the at least one position functions as an air inlet or air inlet, in the vehicle vertical direction by the end edge of the second cover part, wherein in the at least one position the end edge of the second cover part is or forms a lower lip which partially and directly delimits the inflow opening. According to the invention, the second cover part is designed as a pivotable and thus rotatable flap, in particular one that is attached to the crossmember. Since the second cover part, which is also referred to as a flap or is designed as a flap, is pivotable relative to the first cover part, the second cover part can be pivoted relative to the first cover part into different positions, namely at least into the aforementioned positions. For example, the second cover part can be pivoted by an open-loop or closed-loop control system. The second cover panel is a multifunctional component that can be used to influence the following properties and realize them cost-effectively: A first of the properties is temperature control, in particular cooling, which plays a particularly important role in battery electric vehicles. Since cooling is critical in electric vehicles such as battery electric vehicles when stationary, for example during charging, the second cover part as part of the front bumper cover, also known as the vehicle apron, can be lowered in this vehicle state and thus pivoted into the second open position, for example. In particular, it is intended that in the second open position, the end edge is further down in the vehicle vertical direction than in the first open position (at least one position). As a result, the flow cross-section of the inflow opening, also known as the critical inlet cross-section, is compared to the first open position (at least one position), which reduces the pressure loss via the inflow to the heat exchanger, which is, for example, a component of a cooling module. This can subsequently lead to higher air mass flows to and through the heat exchanger, in particular with the same control of the blower, and thus to increased performance when charging the energy storage device, in particular in the form of fast charging, and/or improved climate comfort and/or acoustically quieter air acoustics. With a large opening of the front apron part, i.e. because the flow cross-section of the inlet opening is larger in the second open position than in the first open position, a reverse flow of hot air, to which the vehicle has already released its heat, into an inflow to the heat exchanger, for example in the form of a hot air roller, is also reduced. This can be particularly advantageous. Also at higher vehicle speeds, especially under load, where it unlikely that the vehicle will drive onto a ramp, the flap (second cover part) can be opened if necessary, i.e. moved to the second open position, in order to achieve a particularly high mass flow of air through the air path and thus through the heat exchanger, also known as air mass flow.

A second feature is the so-called ramp angle. As a rule, the ramp angle represents a restriction of the inflow opening and/or the second cover part, in particular with regard to downward positioning in the vehicle vertical direction. Since there is no risk of damage when the vehicle is stationary, as the second cover part cannot touch down, for example, the flap (second cover part) can be lowered further in this state than is permitted by an underbody clearance line, for example. In particular, it is contemplated that, for example, the second cover part is lowered so far, i.e., opened so far, that the second cover part or its end edge touches the ground. It is therefore contemplated that the second cover part, in particular the end edge, is arranged just as far down or low as the ground contact elements when viewed in the other position in the vehicle's vertical direction and, in particular, touches the ground. Even at higher driving speeds, it can be assumed that no bump is encountered, which would allow a particularly wide opening of the second cover part. On the other hand, by optimizing the air supply or the inflow opening in the design position, the inflow opening or its flow cross-section can be made minimally small or particularly small, so that the largest possible ramp angle is made possible when driving at low speed. In addition, the second cover section can be closed as much as possible, for example by means of a closed-loop or open-loop control system, particularly in an off-road and/or water passage mode, in order to minimize the risk of damage as much as possible.

A third feature is pedestrian protection. For example, the second cover part can be pivoted, in particular by way of closed-loop or open-loop control, so that there is as little risk of injury as possible in the event of a collision between the motor vehicle and a person. This adjustment or pivoting of the second cover part can, for example, compensate for differences resulting from a height adjustment of the motor vehicle, for example with a two-axle air suspension and/or variable vehicle load. This also enables optimum positioning at vehicle speed to minimize the risk of injury. In addition, the driver's protection benefits from increased design freedom, for example with regard to compliance, as the second cover part is a separate component with corresponding degrees of freedom.

A fourth of the properties is the air resistance of the vehicle, particularly with regard to airflow around the vehicle. As long as adequate cooling and sufficient protection of the vehicle are ensured, the air resistance can be advantageously kept low by reducing the inflow opening. A fourth of the features is a downforce on a front axle of the motor vehicle. The end edge of the second cover part, which is designed as a lower lip, can, for example, act or be designed as a front spoiler in at least one position and/or in the other position and thus generate downforce on the front axle. The downforce is adjusted, i.e., varied or changed, by adjusting, i.e., pivoting, the second cover part. This effect can be utilized, for example, to increase the downforce, in particular of a front axle, at higher vehicle speeds and possibly in an explicitly desired sports program, or to set it to an advantageously high value, whereby, for example, improved driving dynamics can be achieved.

A sixth of the properties is a closure of the inflow opening, i.e., a reduction of the inflow opening to zero. Preferably, it can be provided that the second cover part is designed in such a way that the inflow opening is closed, for example in the other position or in the third position, meaning that the inflow opening and the flow cross-section are reduced to zero in the other position or in a third position. In particular, by being pivotable relative to the first cover part, the cover part can adjust a quantity or mass and thus a mass flow of the air flowing through the air path, whereby a particularly advantageous, demand-oriented supply of air to the heat exchanger can be achieved.

A seventh of the features can be a new design language. For example, the design of the second cover part as a hinged flap can be implemented in such a way as to emphasize the technical quality and innovation of the vehicle.

For example, the second cover part is rotatably and thus pivotably mounted, in particular at its end opposite the end edge and in particular at its rear end as viewed in the vehicle longitudinal direction, on the crossmember via at least or exactly one hinge and is aligned, for example, in at least one position and/or in the other position such that the second cover part extends forwards from the end in the vehicle longitudinal direction towards the end edge and is thus aligned forwards in the vehicle longitudinal direction.

The aforementioned actuator is, for example, an electromechanical actuator by means of which the second cover part can be pivoted as required. The actuator comprises, for example, a motor, in particular an electric motor, which can provide a force and/or a torque to pivot the second cover part. The force and the torque are also referred to collectively as the adjustment force. For example, a transmission is provided which is preferably designed as a self-locking transmission. For example, the motor can drive the second cover part via the transmission and thus pivot it so that, for example, the adjusting force can be transmitted via the transmission to the second cover part. Alternatively or additionally, a linkage is provided, via which, for example, the second cover part can be driven by the motor, so that, for example, the adjusting force can be transmitted from the motor to the second cover part via the linkage. In particular, if the motor and/or the transmission or the actuator as a whole is designed to be self-locking, forces and torques acting on the second cover part from the outside, for example, which result for example from a pressure during driving operation or in the event of a collision with a person, can be absorbed without control or energy expenditure, without the second cover part being unexpectedly pivoted out of its current position. This means that the second cover part remains in its set position without any control or energy input. An electronic computing device, for example designed as a control unit or also referred to as a control unit, determines an advantageous opening angle, in particular depending on the operating state, and therefore an advantageous position, into which the second cover part is then pivoted, in particular by means of the actuator. The electronic computing device controls the actuator, for example, by means of which the second cover part is adjusted relative to the first cover part as a result of the control and pivoted into one of the positions.

If, for example, not all the desired objectives or requirements can be achieved with one of the positions, i.e., by pivoting the second cover part into one of the positions, one of the positions, also known as the opening angle, is selected and set by prioritizing the objectives or requirements in the control unit. Locking devices and/or electromagnets can help to hold the second cover part in its respective position. Alternatively or additionally, at least one or more springs can be provided to support the pivoting of the second cover part into the respective position. It is also contemplated that at least one or more dampers and/or at least one or more stops and/or at least one or more stiffeners and/or at least one or more impedance masses are provided in order, for example, to avoid disturbing rattling noises.

It is contemplated that, for example, in the vehicle transverse direction, lateral areas of the second cover part can be covered with a respective seal, formed for example as a rubber seal, with respect to the rest of the bumper cover or with respect to the first cover part in order to avoid excessive leakage and thus achieve particularly advantageous aerodynamics.

The forementioned hinge is, for example, sealed upwards in the vehicle vertical direction and downwards in the vehicle vertical direction, so that excessive air turbulence and/or undesired air flows as well as excessive leakages can be avoided. For example, the flow cross-section and thus the inflow opening in at least one position and/or in the other position are designed as a slot, the elongation direction of which runs, for example, at least substantially in the vehicle transverse direction. For example, the inflow opening, in particular the slot, is arranged below a license plate holder arranged at the front when viewed in the vehicle vertical direction, to which a license plate can be attached or is attached.

The positions, i.e., the at least one position and the other position, are stable positions of the second cover part. In other words, the second cover part can be pivoted relative to the first cover part into the positions, i.e., into the at least one position and into the other position, and can be fixed, i.e., locked and thus held in the respective position, i.e., both in the at least one position and in the other position relative to the first cover part. Thus, for example, during a first operating state of the motor vehicle, the second cover part is in the at least one position, wherein or while relative movements between the cover parts do not occur. During a second operating state of the motor vehicle, which for example follows the first operating state or precedes the first operating state in time, the second cover part is for example in the other position, wherein or while relative movements between the cover parts are omitted. In particular, a locking device is provided, by means of which the second cover part can be held, i.e. locked, relative to the first cover part both in the at least one position and in the other position. For example, the locking device can be formed by the actuator, in particular by its self-locking mechanism.

A further embodiment is characterized by an open-loop or closed-loop control system formed, for example, by the aforementioned electronic computing device, which adjusts the positions of the cover part depending on an operating state of the motor vehicle. The operating state can include, for example, a speed of the motor vehicle, a cooling and/or heating requirement, a charging power, a geographical location.

It has been shown to be particularly advantageous if the operating state includes the speed of the motor vehicle, also referred to as vehicle speed, which, for example, travels at this speed. This allows, for example, particularly safe operation to be achieved, especially with regard to a possible accident involving a person.

In a further, particularly advantageous embodiment of the invention, stops are assigned to the cover part, by means of which the movement of the cover part into the positions is delimited. The cover part can thus be moved, for example, from stop to stop, i.e., from one of the stops to the other stop and vice versa and thus, for example, between the positions, but cannot be moved beyond the respective stop. This defines the maximum adjustment range in or via which the cover element can be moved, and the stops can be used to calibrate the positioning of the cover part, for example.

Further details of the invention can be seen from the following description of a preferred exemplary embodiment with the associated drawings.

### BRIEF DESCRIPTION OF THE DRAWINGS

FIG. 1 is a schematic and sectional side view of a motor vehicle designed as a passenger car; and

FIG. 2 is a further schematic and sectional side view of the motor vehicle.

In the figures, identical or functionally identical elements are marked with the same reference signs.

### DETAILED DESCRIPTION OF THE DRAWINGS

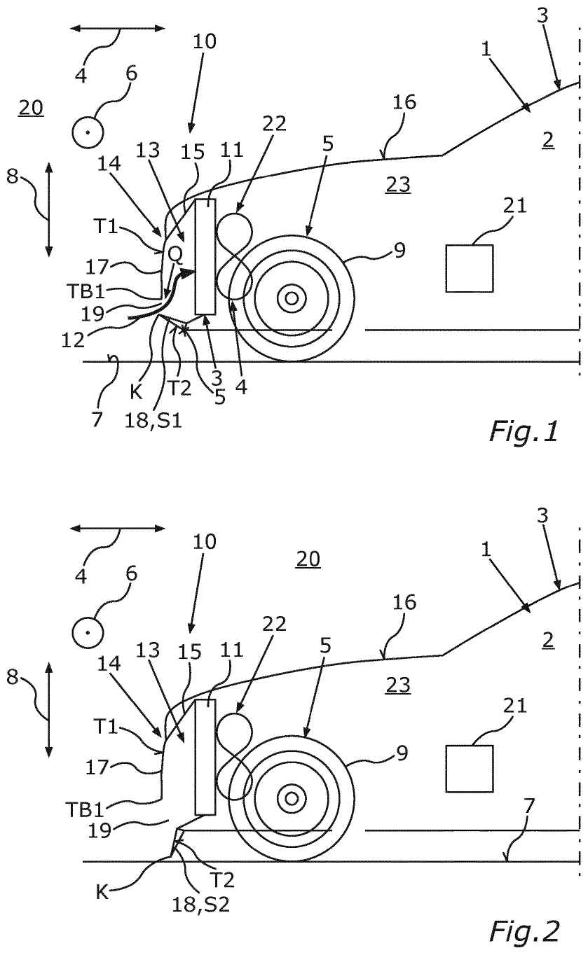

FIG. 1 shows a schematic side view of a detail of a motor vehicle 1, also known simply as a vehicle, which is designed as a motor car and in this case as a passenger car. For example, the motor vehicle 1, whose interior 2, also referred to as the passenger compartment or passenger cell, is formed by a body 3 of the motor vehicle 1, which is designed, for example, as a self-supporting body, is designed as a hybrid vehicle or as a purely electric vehicle, in particular as a battery electric vehicle (BEV). The motor vehicle 1 has at least or exactly two vehicle axles, also simply referred to as axles, arranged in succession in the vehicle longitudinal direction of the motor vehicle 1, wherein the vehicle longitudinal direction is illustrated by a double arrow 4. A first of the vehicle axles is a front axle, and the second vehicle axle is a rear axle, which is arranged behind the front axle relative to a forward direction of travel. Of the vehicle axles, the front axle marked 5 can be seen in FIG. 1. The respective vehicle axle has at least or exactly two vehicle wheels, also simply referred to as wheels. The vehicle wheels of the respective vehicle axle are arranged on opposite sides of the motor vehicle 1 in the transverse direction of motor vehicle, wherein the vehicle transverse direction is illustrated in FIG. 1 by a double arrow 6 and runs perpendicular to the image plane of FIG. 1 and perpendicular to the vehicle longitudinal direction. The vehicle wheels are ground contact elements, via which the motor vehicle 1 is supported or can be supported downwards on a ground 7 in the vertical direction of the motor vehicle 1. The vehicle vertical direction is illustrated in FIG. 1 by a double arrow 8 and runs perpendicular to the vehicle transverse direction and perpendicular to the direction in which the vehicle is moving. If the motor vehicle 1 is driven along the ground 7 while the motor vehicle 1 is supported downwards via the ground contact elements on the ground 7 in the vehicle vertical direction, the ground contact elements slide and/or roll, in particular directly, on the ground 7. Of the vehicle wheels of the vehicle axle 5, a vehicle wheel designated 9 can be seen, which is also referred to as the front wheel.

The motor vehicle 1 has, for example, at least one electric machine, not shown in FIG. 1, by means of which the motor vehicle 1 can be driven, in particular purely, electrically. Furthermore, the motor vehicle 1 has an electrical energy storage device, which is also referred to as a battery or is designed as a battery, in particular as a secondary battery. Electrical energy, in particular electrochemical energy, can be stored or is stored by means of the electrical energy storage device. In order to drive the motor vehicle 1 by means of the electric motor, the electric motor is supplied with the electrical energy stored in the energy store.

The motor vehicle 1, the front of which is denoted 10 in FIG. 1, also has at least one heat exchanger, formed in the present case as a radiator 11, which is arranged on the front 10, through which a fluid can flow and around which air can flow, in this case in the form of cooling air. The cooling air flowing towards the radiator 11 and thus flowing to and around the radiator 11 or the flow thereof is illustrated in FIG. 1 by an arrow 12. The fluid is preferably a liquid, wherein the fluid above the radiator 11 can be cooled by means of the cooling air flowing around the radiator 11. As a result, the cooled fluid can, for example, cool a component such as the electric machine and/or the energy store.

It can be seen that the radiator 11 is a heat exchanger, which is used as a radiator to cool the fluid in the example shown. Therefore, the air flowing around the radiator 11 is used here as cooling air. Of course, the previous and following embodiments can also be transferred to such an embodiment in which the heat exchanger is used alternatively or additionally to heat the fluid. In this case, heat can be transferred from the air flowing around the heat exchanger via the heat exchanger to the fluid flowing through the heat exchanger. This is possible, for example, in hot pump operation. The heat exchanger is thus designed or intended for temperature control, i.e. for cooling and/or heating the fluid. In other words, the fluid can be temperature-controlled, that is to say cooled and/or heated, via the heat exchanger by means of the air.

The front 10 of the motor vehicle 1 also has a cooling air path 13 through which the cooling air can flow and via which the cooling air can be fed to the radiator 11. This allows the radiator 11 to be supplied with cooling air. The motor vehicle 1 also has a bumper cover 14, which is arranged on the front 10 and by which, for example, the radiator 11 is at least partially, in particular at least predominantly and thus at least more than half or completely, overlapped towards the front in the vehicle longitudinal direction and thus covered. It is also contemplated that the radiator 11 is at least partially, in particular at least predominantly or completely, overlapped on both sides towards the outside in the vehicle transverse direction by the bumper cover 14 and thus covered. The bumper cover 14 is also referred to as front cover or front apron or apron.

In the exemplary embodiment shown in the figures, the cooling air path 13 is a cooling duct through which the cooling air can flow. In the direction of flow of the cooling air flowing through the cooling air path 13, the cooling air path 13, in particular the entire cooling air path 13, is arranged upstream of the radiator 11, so that, for example, the cooling air path 13 ends at the radiator 11. In particular, it is provided that in the exemplary embodiment shown in the figures the entire cooling air path 13 is arranged upstream of the radiator 11 in the vehicle longitudinal direction, i.e., further forward than the radiator 11. In particular, the cooling air path 13 or the cooling duct is completely delimited along its circumferential direction running around the direction of flow of the cooling air flowing through the cooling air path 13 by a duct element 15 designed, for example, as a solid body, for example, over the entire extension of the cooling air path 13 running from a start to an end of the cooling air path 13. The cooling air path 13 ends at its end, wherein the end of the cooling air path 13 is arranged at the radiator 11, for example, due to the fact that the cooling air path 13 ends at the radiator 11. The beginning of the cooling air path 13 is arranged upstream of the end of the cooling air path 13 in the direction of flow of the cooling air flowing through the cooling air path 13. The beginning of the cooling air path 13 is also referred to as the start of the cooling air path 13, as the cooling air path 13 starts at the beginning.

In order to realize particularly advantageous aerodynamics of the motor vehicle 1 on the one hand and a particularly advantageous supply of cooling air to the radiator 11 on the other hand, it is provided that the bumper cover 14 has a first cover part 17 forming a first part T1 of an external skin 16 of the motor vehicle 1 and a second cover part 18 forming a second part T2 of the external skin 16, which is pivotable about a pivot point S extending at least substantially in the vehicle transverse direction of the motor vehicle 1, relative to the cover part 17 between at least two positions S1 and S2 (FIG. 2).

It can be seen from FIG. 1 that in the position S1, also referred to as the first position, an inflow opening 19 of the cooling air path 13, in which the cooling air can be introduced from a surrounding environment 20 of the motor vehicle 1 via the inflow opening 19, is in each case directly delimited upwards in the vehicle vertical direction by a partial area TB1 of the cover part 17 and downwards in the vehicle vertical direction by an end edge K of the second cover part 18, which is arranged below the partial area TB1 in the vehicle vertical direction in the first position S1. In the first position S1, the inflow opening 19 has a larger-than-zero flow cross-section Q that the cooling air can flow through and that in the first position S1 is the smallest flow cross-section of the cooling air path 13 through which the cooling air can flow on its way from the inlet opening 19 to the end of the cooling air path 13 and thus to the radiator 11. The cooling air path 13 begins at or with the inflow opening 19, so that the beginning of the cooling air path 13, also referred to as the flow path, coincides with the inflow opening 19, and is thus arranged at the inflow opening 19. Since the cover part 18 is pivotable about the pivot axis S relative to the cover part 17, the cover part 18 is a flap, in particular a lower flap. Since the flow cross-section Q of the inflow opening 19 is greater than zero in the first position S1, the flow cross-section Q and thus the inflow opening 19 are open, open or released in the first position S1, so that in the exemplary embodiment shown in FIG. 1 the first position S1 is a first open position. The position S2 of the cover part 18, also referred to as the second position and shown in FIG. 2, is a second open position. In the second open position, the inflow opening 19 of the cooling air path 13 is delimited upwards in the vehicle vertical direction by the partial area TB1 of the first cover part 17 and downwards in the vehicle vertical direction by the end edge K of the second cover part 18 which is also arranged in the second position S2 in the vehicle vertical direction below the partial area TB1. In the second position S1, the flow cross-section Q of the inflow opening 19 is greater than zero and greater than in the first position S1. It can be seen that the end edge K in of the second position S2 is arranged further down, thus lower in the vehicle vertical direction than in the first position S1, so that the cover part 18 or its end edge K in the vehicle vertical direction is lowered downwards to pivot or adjust the cover part 18 from the position S1 to the position S2.

It is contemplated that the cover part 18 can be pivoted into a third position about the pivot axis S relative to the cover part 17. Since the flow cross-section Q is also greater than zero in the second position S2, so that the flow cross-section Q and thus the inflow opening 19 are also opened, open or released in the second position S2, the second position S2 is a second open position. The third position is, for example, a closed position, in which the inflow opening 19 is closed and therefore the flow cross-section Q and thus the inflow opening 19 are reduced to zero. As a result, the cooling air path 13 is fluidically blocked. In the third position, for example, the end edge K is arranged further upward than positions S1 and S2 when viewed in the vehicle vertical direction, in particular in such a way that in third position the end edge K is in contact, in particular directly, with the partial area TB1. This allows particularly advantageous aerodynamics to be realized. In addition, a particularly demand-oriented supply of cooling air to the radiator 11 can be realized.

It is contemplated that, in position S2, the end edge K of the second cover part 18, with the exception of the ground contact elements of the motor vehicle 1, is the lowest point of the motor vehicle 1 when viewed downwards in the vehicle vertical direction. In particular, it is contemplated that, in the second position S2, the end edge K touches the ground 7. For example, the motor vehicle 1 has an actuator 21, shown particularly schematically in FIG. 1, which is designed in particular as an electrically operable actuator. For example, the actuator 21 is an electromechanical actuator. By means of the actuator 21, the cover part 18 can be driven and thereby pivoted about the pivot axis S relative to the cover part 17.

The position S1 is, for example, a regular position of the cover part 18. Furthermore, it is contemplated that the inflow opening 19 in the first position S1 and/or in the second position S2 is designed as a slot, the elongation direction of which extends, for example, at least substantially in the transverse direction. The end edge K is or forms a lower lip by which the slot or the inflow opening 19 is directly delimited at the bottom in the vehicle vertical direction. The cover part 18 and thus in particular the end edge K are designed, for example, in such a way that in the regular position (position S1) requirements on underbody clearance or a ramp angle of the motor vehicle 1 are met and that, for example, a low-resistance flow air around the motor vehicle 1 is ensured. It is contemplated that, in the vehicle transverse direction, further, third cover parts of the bumper cover 14 are attached to the cover part 18, in particular on both sides, wherein for example the third cover parts are immovable relative to the first cover part 17, for example. Thus, for example, the cover part 18 does not extend over the entire width of the bumper cover 14 in the vehicle transverse direction. In the second position S2, the cover part 18 is wider open than in the first position S1, and in the second position S2, the flow cross-section Q of the inflow opening 19 and thus the inflow opening 19 itself are significantly larger than in the first position S1. In both positions S1 and S2, however, the flow cross-section Q and thus the inflow opening 19 are open, thus greater than zero, so that both in the first position S1 and in the second position S2, for example when the motor vehicle 1 is moving forwards, cooling air can flow out of the surrounding environment 20, for example as a result of airstream or formed by airstream, can flow through the inflow opening 19 and thus flow into the cooling air path 13 via the inflow opening 19. The second position S2 makes it possible, for example, for a particularly high mass flow of cooling air to flow through the cooling air path 13 and thus flow around the radiator 11.

For example, in order to convey the cooling air through the cooling air path 13 and/or to support a flow of the cooling air through the cooling air path 13, a blower 22, also known as a fan and for example electrically operable, is associated with the radiator 11, by means of which the cooling air can be conveyed through the cooling air path 13. In the direction of flow of the cooling air flowing through the cooling air path 13, the blower 22 is arranged downstream of the radiator 11, wherein in the present case the blower 22 is arranged behind the radiator 11 when viewed in the vehicle longitudinal direction. With the same operation, i.e., with the same control of the blower 22, a higher mass flow of cooling air can flow through the cooling air path 13 in the second position S2 than in the first position S1, since the flow cross-section Q and thus the inlet opening 19 are larger in the second position S2 than in the first position S1. This can, for example, lead to increased performance when charging the energy storage device, particularly in the form of fast charging, and/or to improved climate comfort and/or acoustically quieter fan acoustics.

The actuator 21 is designed as an electromechanical actuator, for example. The actuator 21 can, for example, provide a force and/or a torque in order to pivot the cover part 18. The torque and/or the force can, for example, be transmitted from the actuator 21 to the cover part 18 via a linkage and/or a transmission, so that, for example, the cover part 18 can be driven by the actuator 21 via the linkage and/or the transmission. In other words, for example, a mechanism comprising the transmission and/or the linkage is provided, by means of which the cover part 18 can be driven by the actuator 21 and can thus pivoted relative to the cover part 17. The mechanism, i.e. the transmission and/or the linkage, are preferably designed to be self-locking and are dimensioned, for example, such that even at high vehicle speeds of the motor vehicle 1 the cover part 18, which is designed as a flap, remains in its set position S1 or S2 without the actuator 21 being actuated and actively providing a force or torque to hold the cover part 18 in its position. If the cover part 18 is opened, i.e. pivoted from position S1 to the second position S2, for example the cover part 18, in particular the end edge K, is lowered to the ground 7, i.e. until the end edge K touches the ground 7. For example, a sensor, in particular in the actuator 21, detects obstacles and/or misbehavior so as not to damage either the cover part 18 or objects arranged in the vicinity 20. By lowering the cover part 18 or the end edge K to the ground 7, it is possible to prevent hot air blown out by the radiator 11 from being sucked in from the front, thereby reducing the effectiveness of the cooling. For example, at least one or more seals, in particular in the form of rubber seals, can form an aerodynamically tight seal on the side of the cover part 18 to the surrounding, remaining bumper cover 14. For example, the actuator 21 and thus the cover panel 18 can be operated by way of closed-loop or open-loop control. For example, the actuator 21 is controlled by way of closed-loop or open-loop control in such a way that the cover part 18 is or can only be opened when the motor vehicle 1 is stationary and only when required. For example, as soon as the motor vehicle 1 is ready to drive, the cover panel 18 is closed, for example, and thus pivoted from the S2 position into the S1 position or into the third position. If it is not necessary to open or pivot the cover part 18 into position S2, or if this is estimated or determined to be unnecessary, the cover part 18 remains in the first position S1 or in the third position. This can, for example, prevent excessive contamination of the radiator 11.

In principle, it would be contemplated to pivot or move the cover part 18 or the end edge K upwards, in particular starting from position S1, in order to subsequently close the inflow opening 19, in particular completely, and thus reduce the flow cross-section Q and thus the inflow opening 19 to zero. In this way, for example, an engine compartment, which is arranged behind the radiator 11, in particular behind the blower 22, for example in the vehicle longitudinal direction and is designated 23 in FIG. 1, can be protected from excessive heating and from excessive cooling by the surrounding environment 20, in particular if no cooling or heating is required. In addition, the air resistance of the motor vehicle 1 can be kept particularly low.

### LIST OF REFERENCE SIGNS

1 motor vehicle
2 interior
3 body
4 double arrow
5 front axle
6 double arrow
7 ground
8 double arrow
9 vehicle wheel
10 front
11 heat exchanger
12 arrow
13 air path
14 bumper cover
15 duct element
16 external skin
17 first cover part
18 second cover part
19 inflow opening
20 surrounding environment
21 actuator
22 blower
23 engine compartment
K end edge
T1 first part
T2 second part
TB1 partial area
S pivot axis
S1 first position
S2 second position

1.-15. (canceled)

16. A motor vehicle, comprising:
at least one heat exchanger through which a fluid flows and around which air is flowable, wherein the fluid is to be temperature-controlled via the air;
an air path through which the air is flowable and by which, to supply the heat exchanger with the air, the air is guided to the heat exchanger; and
a bumper cover arranged on a front of the motor vehicle,
wherein the bumper cover comprises a first cover part, which forms a first part of an external skin of the motor vehicle, and a second cover part, which forms a second part of the external skin and is pivotable relative to the first cover part between at least two positions,
wherein in at least one of the two positions:
(i) an inflow opening of the air path, into which the air from a surrounding environment of the motor vehicle is introducable via the inflow opening, is delimited upwards in a vehicle vertical direction through a partial area of the first cover part and downwards in the vehicle vertical direction through an end edge of the second cover part arranged below the partial area in the at least one of the two positions in the vehicle vertical direction, in each case directly; and
(ii) the inflow opening has a flow cross-section through which the air is flowable, which in the at least one of the two positions is a smallest flow cross-section of the air path through which the air can flow.

17. The motor vehicle according to claim 16, wherein
the second cover part is pivotable relative to the first cover part between the two positions about a pivot axis extending in a transverse direction of the vehicle.

18. The motor vehicle according to claim 16, wherein
in the other position, the inflow opening is closed and the air path is fluidically blocked.

19. The motor vehicle according to claim 16, wherein, in the other position:
(i) the inflow opening of the air path is delimited upwards in the vehicle vertical direction by the partial area of the first cover part and downwards in the vehicle vertical direction by the end edge of the second cover part arranged in the other position below the partial area in the vehicle vertical direction, in each case directly; and
(ii) the flow cross-section of the inflow opening is greater than in the at least one position.

20. The motor vehicle according to claim 19, wherein
in the other position, the flow cross-section of the inlet opening is the smallest flow cross-section of the air path through which the air can flow.

21. The motor vehicle according to claim 19, wherein
the second cover part is pivotable relative to the first cover part into a third position, in which the inflow opening is closed and the air path is fluidically blocked.

22. The motor vehicle according to claim 19, wherein
in the other position, the end edge of the second cover part, with the exception of ground contact elements of the motor vehicle, which can be supported on a ground via the ground contact elements in the vehicle vertical direction, is a lowest point of the motor vehicle when viewed downwards in the vehicle vertical direction.

23. The motor vehicle according to claim 16, wherein
the second cover part is held on a crossmember of the motor vehicle so as to be pivotable relative to the first cover part and relative to the crossmember.

24. The motor vehicle according to claim 16, further comprising:
an actuator, by which the second cover part is driven and pivoted relative to the first cover part from the at least one position into the other position and/or from the other position into the at least one position.

25. The motor vehicle according to claim 24, further comprising:
a transmission and/or linkage, via which the second cover part is moved by the actuator.

26. The motor vehicle according to claim 25, wherein
the transmission and/or linkage is self-locking.

27. The motor vehicle according to claim 16, further comprising:
at least one seal, by which the first and second cover parts are sealed with respect to one another in the at least one position and/or in the other position.

28. The motor vehicle according to claim 16, further comprising:
an open-loop or closed-loop control system which adjusts the positions of the second cover part as a function of an operating state of the motor vehicle.

29. The motor vehicle according to claim 28, wherein
the operating state comprises a speed of the motor vehicle.

30. The motor vehicle according to claim 16, wherein
stops are assigned to the second cover part, by which the movement of the second cover part into the positions is delimited.
